(19) United States
(12) Patent Application Publication
(10) Pub. No.: US 2025/0050380 A1
(43) Pub. Date: Feb. 13, 2025

(54) Screening Apparatus

(71) Applicant: M&K Holdings (Ireland) Limited, Dungannon, Tyrone (GB)

(72) Inventors: Nigel Rafferty, Dungannon, Tyrone (GB); Desmond Rafferty, Dungannon, Tyrone (GB)

(21) Appl. No.: 18/721,858

(22) PCT Filed: Dec. 7, 2022
(86) PCT No.: PCT/EP2022/084867

§ 371 Date: Jun. 19, 2024

(30) Foreign Application Priority Data
Jan. 24, 2022 (GB) 2200829.6

(51) Int. Cl. B07B 1/15

(52) U.S. Cl. CPC B07B 1/155

(57) ABSTRACT

The present invention relates to a screen for accepting waste material, the waste material comprising fines and oversize material, wherein the screen comprises: a trough with a top opening, a base opening for discharging the fines material and an oversize material outlet for discharging the oversize material; driven elongate rotating members for causing movement of the waste material, wherein each rotating member comprises a shaft and a plurality of mutually parallel blades, wherein each blade independently has a plurality of radial protrusions which act on the material during the movement thereof, wherein for one or more blades on each shaft independently, at least one of the radial protrusions on the or each blade is an extended radial protrusion, wherein the material to be screened is introduced at one end of the shafts and expelled at the other end, characterised in that each elongate rotating member independently is held and rotatably mounted at both ends, wherein the driven elongate rotating members comprise a first plurality of driven elongate rotating members disposed in a first arc along one side and along at least a portion of the base of the trough for causing circular or helical flow of the waste material and a second plurality of driven elongate rotating members disposed in a second arc along the other side of the trough and along at least a portion of the base of the trough for causing circular or helical flow of the waste material, wherein, for each plurality of driven elongate rotating members, at least one elongate rotating member runs at a different speed to the other elongate rotating members, and wherein the speed of the elongate rotating members does not decrease towards the top opening of the trough.

The present invention relates to material handling equipment, in particular to screening apparatus for use in waste material handling, for example for use in the recycling industry.

### BACKGROUND TO THE INVENTION

Within the material handling industry there is a need for the ability to remove valuable material, for example stones, from other inert landfill material such as soil and muck.

Material collected from the demolition of buildings, excavations or by reclamation of rocky soil exhibits heterogeneous dimensions, typically contains debris of value combined with rubble, sand and other objects of small dimensions. There are a number of conventional mechanical screening methods used to separate these materials into multiple grades by particle size.

At the high throughput expensive end are washing plants. Washing plants process construction and civil engineering wastes into clean homogenous recycled product by washing the material to remove contaminants and extract silt and clay which bind the constituents together. The throughput can be very high, up to about 120 tonnes per hour. However, washing plants are very expensive to purchase, hire and operate. As well as being high cost, the whole process uses a lot of energy and water. Furthermore, the waste/dirty water is a big issue and has to be settled in settle ponds, often with the addition of chemicals to speed up the settling process.

On the cheaper, less efficient, side screening buckets may be used to separate material. A screening bucket must be attached to an excavating machine. The bucket typically has rotatable drums which effect screening, crushing or mixing of a material present in the bucket and at the same time deliver a screened, crushed or mixed material out of the bucket between or through the drums. Disadvantages with such buckets include the fact that the throughput is very low, usually about 20 tonnes per hour and the process is laborious for the driver of the excavator who has to frequently slew around between the different piles of material, for example between piles of stones and piles of fines material.

It is therefore an object of the present invention to provide a screen for inert landfill material which alleviates the above disadvantages and/or provides a suitable alternative.

### SUMMARY OF THE INVENTION

The present invention relates to apparatus for use in screening and conveying waste material, which allows oversize material to self-discharge and which avoids build-up of waste material on the apparatus.

Accordingly, a first aspect of the present invention is a screen for accepting waste material, the waste material comprising fines and oversize material, wherein the screen comprises:
a trough with a top opening, a base opening for discharging the fines material and an oversize material outlet for discharging the oversize material;
driven elongate rotating members for causing movement of the waste material, wherein each rotating member comprises a shaft and a plurality of mutually parallel blades, wherein each blade independently has a plurality of radial protrusions which act on the material during the movement thereof, wherein for one or more blades on each shaft independently, at least one of the radial protrusions on the or each blade is an extended radial protrusion,
wherein the material to be screened is introduced at one end of the shafts and expelled at the other end,
characterised in that each elongate rotating member independently is held and rotatably mounted at both ends,
wherein the driven elongate rotating members comprise a first plurality of driven elongate rotating members disposed in a first arc along one side and along at least a portion of the base of the trough for causing circular or helical flow of the waste material and a second plurality of driven elongate rotating members disposed in a second arc along the other side of the trough and along at least a portion of the base of the trough for causing circular or helical flow of the waste material,
wherein, for each plurality of driven elongate rotating members, at least one elongate rotating member runs at a different speed to the other elongate rotating members, and wherein the speed of the elongate rotating members does not decrease towards the top opening of the trough.

By extended radial protrusion is meant a radial protrusion on a particular blade that is longer than the other radial protrusions on that blade.

The driven elongate rotating members together form a screening surface, wherein fines material falls between the rotating members and oversize material does not.

The elongate rotating members cause circular or helical flow of the waste material above the screening surface. The material is introduced at one end of the shafts and expelled at the other end. The curved placement of the elongate rotating members results in the waste material being flipped and tossed which increases the screening efficiency and causes any sticky material to break up. The speed of the rotating members does not decrease in the direction of material flow, i.e., towards the top of each arc.

During rotation of the shafts of the elongate rotating members, each extended radial protrusion on a particular shaft comes closer to the shafts on either side of that shaft, clearing any debris from the adjacent shafts and any debris stuck between the blades of the adjacent shafts.

Due to the fact that not all of the elongate rotating members run at the same speed, the extended radial protrusions do not always hit an adjacent shaft at the same point every revolution, only clearing one particular area of the shaft. Instead, the or each extended radial protrusion of the rotating member running at a different speed hits an adjacent shaft at a different location every revolution, cleaning right around the adjacent shaft.

The rotating members do not slow down in the direction of material flow. If they were to get slower in the direction of material flow, the material would back up, and would be pulled down by the faster rotating member.

In a preferred embodiment, the rotating members are interconnected. Alternatively, the rotating members are each independently driven.

There are preferably at least three elongate rotating members per plurality, particularly preferably from about 4 to about 12, e.g., 5 or 6.

In a preferred embodiment, the rotating members rotate in the range of from about 90 to about 200 rpm. However, this is not considered to be limiting and other speeds are considered to be within the scope of the invention. Particularly preferably, the rotating members rotate at variable speed.

The rotating members are preferably actuated by a motor and mechanical transmission. The motor may be hydraulic or electric, for example a variable speed electric motor. In the embodiment wherein the rotating members are interconnected, a first toothed pulley is typically keyed onto the output shaft of the motor and a plurality of second toothed pulleys are keyed onto respective ends of the rotating members and coupled to the first toothed pulley by means of chains.

The speeds of the rotating members on one side of the trough are preferably a mirror of the speeds on the opposite side, i.e., opposing shafts run at identical speeds.

In a particularly preferred embodiment, the first plurality of rotating members run in the opposite direction to the second plurality of rotating members. For example, if the shafts of the first plurality of driven elongate rotating members operate in the clockwise direction, shafts of the second plurality of driven elongate rotating members operate in the anti-clockwise direction and vice versa.

Preferably, each elongate rotating member independently is adjacent at least one shaft on either or both sides running at a different speed, particularly preferably by use of different size sprockets.

Preferably, the radial protrusions are curved radial protrusions. For example, the blades may be polyurethane stars such as curved, hexagonal, circular, or straight legged stars. However, this is not to be considered limiting and other materials and shapes are encompassed within the scope of the invention, provided each blade has at least one radial protrusion longer than the others on that blade.

In a further aspect the invention provides a screening apparatus comprising a frame, a feed conveyor mounted at one end of the frame and a screen as described hereinabove.

Preferably, the screen is mounted on the frame about a pivot axis and is pivotable about the pivot axis such that the inlet end and/or discharge end of the screen may be raised or lowered. In these embodiments, the elongate rotating members are each independently perpendicular to the pivot axis. However, this is not to be considered limiting and the screen may instead be mounted to the frame at a predetermined fixed angle such that the oversize material outlet is lower than the inlet end of the screen, preferably wherein the predetermined fixed angle is in the range of from about 2 degrees to about 15 degrees, particularly preferably in the range of from about 5 degrees to about 10 degrees, e.g., 7 degrees.

In a preferred embodiment, the pivot axis is at the outlet end of the screen. However, this is not to be considered limiting and the pivot axis may alternatively be located at the inlet end or anywhere between the inlet and outlet ends of the screen.

In a preferred embodiment, the screen is mounted on the frame such that at least a portion of the top opening of the trough is located beneath the feed conveyor. Alternatively, or additionally, the screening apparatus further comprises a static feed plate between the feed conveyor and the screen such that the waste material to be screened falls from the feed conveyor onto the static feed plate, bounces or slides off the plate and then drops into the screen.

The screening apparatus according to the invention is preferably static for placement above containment bays for collecting the discharged fines and oversize material. Such containment bays may be made of shuttered concrete, or manufactured from steel, concrete blocks and the like. However, rather than being static, the screening apparatus may be provided with any one or more of wheels, tracks and hooklift.

The oversize material outlet is preferably at the front of the trough, i.e., at the opposite end of the screen to incoming water material.

In a preferred embodiment, the screen further comprises a feed inlet for accepting the waste material from the feed conveyor such that the feed inlet is beneath the feed conveyor, particularly preferably wherein the feed inlet is in the form of a chute, e.g., a three-sided chute. In this embodiment, the outlet is preferably at the opposite end of the trough to the inlet.

The screen is preferably pivotally mounted to the frame such that the angle may be altered to dictate retention time of the waste material within the trough. For example, the screen may be mounted at 0 degrees with respect to the frame. Alternatively, for transport, the screen may be pivoted along the pivot axis such that the screen is angled and mounted with the inlet end lower than the outlet end in order to retain the material, e.g., with the outlet end upwards up to about 2.5 degrees.

Alternatively, the screen may be pivoted along the pivot axis such that the screen is angled and mounted with the inlet end higher than the outlet end, e.g., the outlet lowered up to about 15 degrees, such that the material remains on the screen for a shorter time. In this embodiment, the larger the angle, the less time the material is on the screen.

In a preferred embodiment, the screening apparatus further comprises a ram assembly to alter the pivot angle of the screen with respect to the frame. The ram assembly may be directly attached to the screen or may be located elsewhere on the screening apparatus. Alternatively, the screen could be lifted, e.g., using a crane, and pinned in position.

In a preferred embodiment, the screening apparatus further comprises one or more conveyors to collect and stockpile screened material.

Additionally, or alternatively, the screening apparatus preferably comprises a plurality of screens in series, particularly preferably two screens in series. The plurality of screens may be in line or stepped with respect to each other. In these embodiments only the first screen may be provided with a feed inlet. Both embodiments enable an increase in the screening length.

In addition to enabling increased screen length, the screens in series may also be used to give additional product sizes, i.e., the first screen allowing fines material of a diameter up to about 10 mm through its base opening, the second allowing fines material of a diameter up to about 25 mm through its base opening and the remaining material exiting the machine through the oversize material outlet.

In order to enable the screen to be removed from the screening apparatus for ease of maintenance of the screen, the screen is preferably removably mounted to the frame. For example, the screen preferably slides with respect to the frame for removal. The feed conveyor is preferably also slidably mounted to the frame such that it can be moved out of the way to facilitate removal of the screen.

### BRIEF DESCRIPTION OF THE DRAWINGS

Certain preferred embodiments of the present invention will now be described, by way of example only, with reference to the accompanying drawings in which:

FIG. 1 shows a perspective view of the screen according to the invention;

FIG. 2a shows a plan view of the screen of FIG. 1;

FIG. 2b shows a sectional view along line A-A in FIG. 1;

FIG. 2c shows a sectional view along line B-B in FIG. 1;

FIG. 3 shows an end view of the screen of FIG. 1;

FIG. 4 shows a rear perspective view of the screen of FIG. 1;

FIG. 5 shows an outlet end view of the screen of FIG. 1;

FIG. 6 shows a preferred blade with extended radial protrusion for use on the elongate rotating members of the screen of FIG. 1; and

FIG. 7 shows a perspective view of a preferred screening apparatus according to the invention.

### DETAILED DESCRIPTION

Various embodiments of the present invention will be described in detail with reference to the drawings, where like reference numeral represent like parts and assemblies throughout the several views.

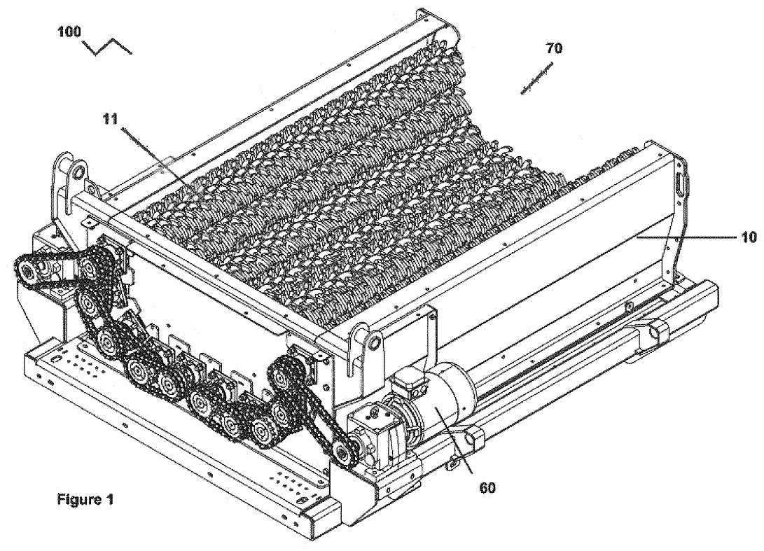

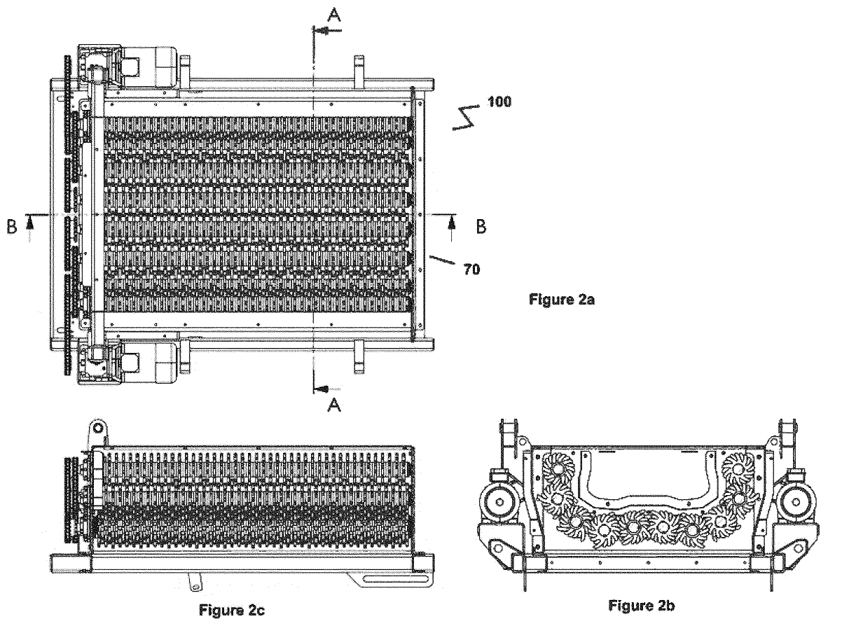

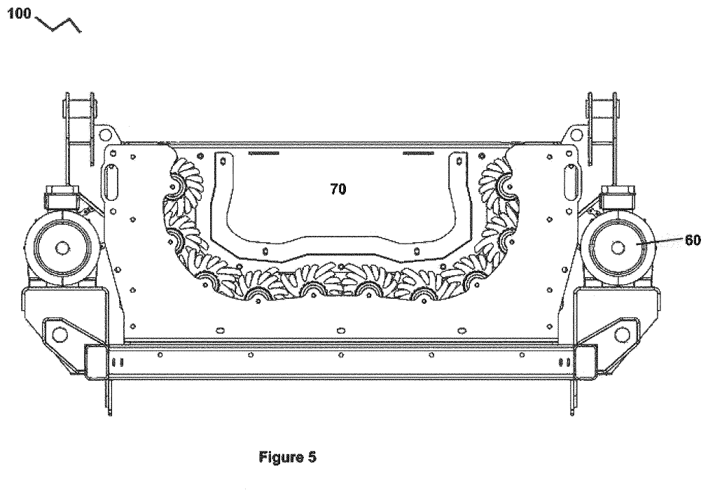

Referring to the drawings, FIGS. 1 to 5 show a preferred screen according to the invention, generally referred to herein by reference numeral 100, for accepting waste material, the waste material comprising fines and oversize material.

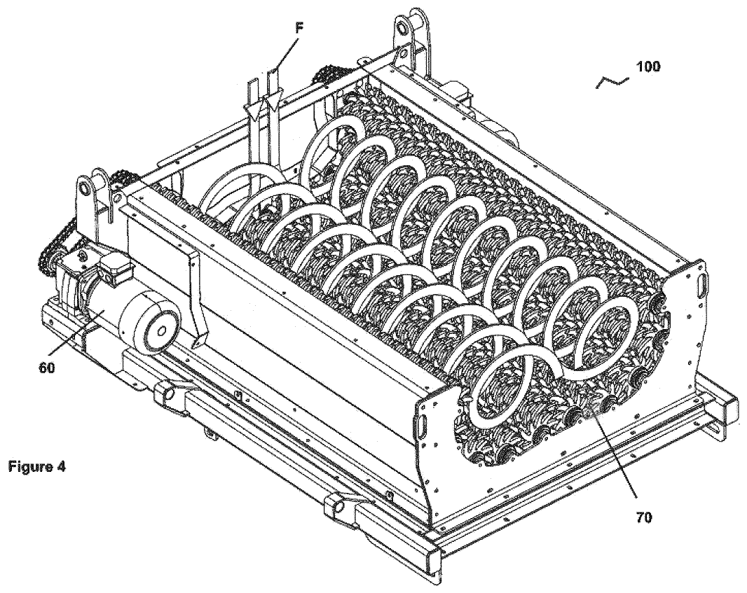

Screen 100 comprises a trough 10 with feed inlet 11 and base opening (not shown) and a plurality of driven elongate rotating members 21, 22, 23, 24, 25, 31, 32, 33, 34, 35 for causing movement of waste material. Arrows F in FIG. 4 show the direction of flow of the material within screen 100 during use.

Inlet 11 is for accepting waste material, e.g., from a hopper. Base opening (not shown) is for discharging fines material.

Five interconnected driven elongate rotating members 21, 22, 23, 24, 25 are disposed in a first arc 20 along one side and along at least a portion of the base of trough 10 for causing circular or helical flow of waste material within trough 10 above the screening surface formed by arc 20 such that the speed of the elongate rotating members does not decrease in the direction of material flow. In the preferred embodiment shown, the speed rotating member 21 runs at is faster than the speed rotating member 22 runs at, the speed rotating member 22 runs at is faster than the speed rotating members 23 and 24 run at and the speed rotating members 23 and 24 run at is faster than the speed rotating member 25 runs at.

Another five interconnected driven elongate rotating members 31, 32, 33, 34, 35 are disposed in an opposing second arc 30 along the other side of trough 10 for causing a second, opposing circular or helical flow of waste material within trough 10 above the screening surface formed by arc 30. The speeds rotating members 31, 32, 33, 34, 35 run at mirror those of rotating members 21, 22, 23, 24, 25, i.e., rotating members 21 and 31 run at identical speeds and so on. In the embodiment shown, the different speeds are achieved by using different size sprockets.

Rotating members 21, 22, 23, 24, 25 run in the opposite direction to rotating members 31, 32, 33, 34, 35. For example, if the shafts of interconnected driven elongate rotating members 21, 22, 23, 24, 25 operate in the clockwise direction, shafts of interconnected driven elongate rotating members 31, 32, 33, 34, 35 operate in the anti-clockwise direction and vice versa.

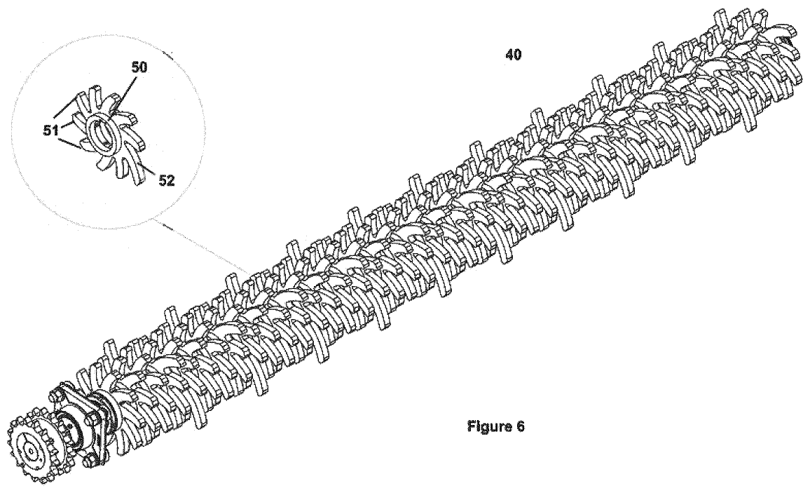

Each rotating member 21, 22, 23, 24, 25, 31, 32, 33, 34, 35 comprises a shaft 40 and a plurality of mutually parallel blades 50, wherein each blade independently has a plurality of curved radial protrusions 51 which act on the material during the movement thereof, wherein one of the radial protrusions on each blade 50, extended radial protrusion 52, is longer than the other radial protrusions 51 on that blade. This is more clearly shown in FIG. 6.

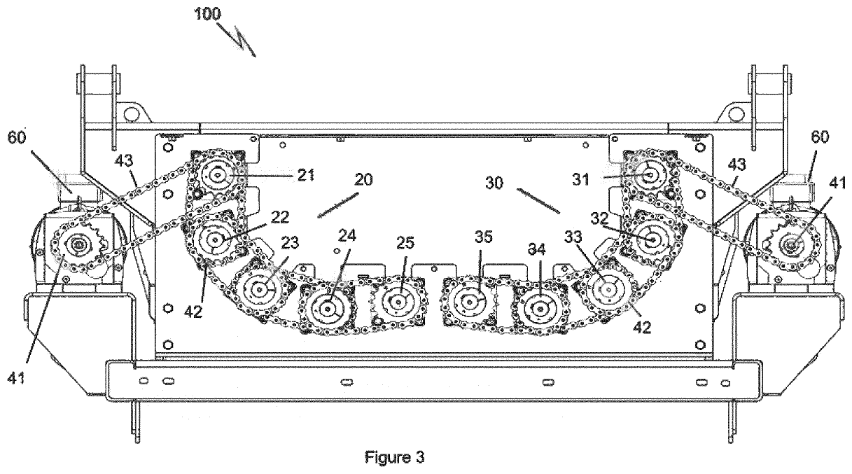

As is clear from FIG. 3, first toothed pulley 41 is keyed onto output shaft 61 of variable speed electric motor 60 and a plurality of second toothed pulleys 42 are keyed onto respective ends of rotating members 21, 22, 23, 24, 25 outside of trough 10 and coupled to first toothed pulley 41 by means of chains 43.

The number of teeth on the ends of rotating members 21, 22, 23, 24, 25 increases in the direction of material flow, with rotating member 21 having 15 teeth, rotating member 22 having 16 teeth, pulleys 44 and 45 having 17 teeth and pulley 46 having 18 teeth.

For each blade 50, during rotation of shafts 40, extended radial protrusion 52 comes closer to shafts on either side than radial protrusions 51 on that blade, thus clearing debris from adjacent shafts and stuck between the blades. Due to the fact that not all rotating members run at the same speed, extended radial protrusion 52 does not always hit an adjacent shaft at the same point every revolution, only clearing one particular area of the shaft. Instead, each extended radial protrusion 52 of the rotating member running at a different speed hits an adjacent shaft 40 at a different location every revolution, cleaning right around the adjacent shaft.

Screen 100 further comprises oversize material outlet 70 for discharging oversize material.

In the preferred embodiment illustrated in FIG. 6, blades 30 are curved polyurethane stars. However, this is not to be considered limiting and other materials and shapes are encompassed within the scope of the invention, provided each blade has at least one radial protrusion longer than the others on that blade.

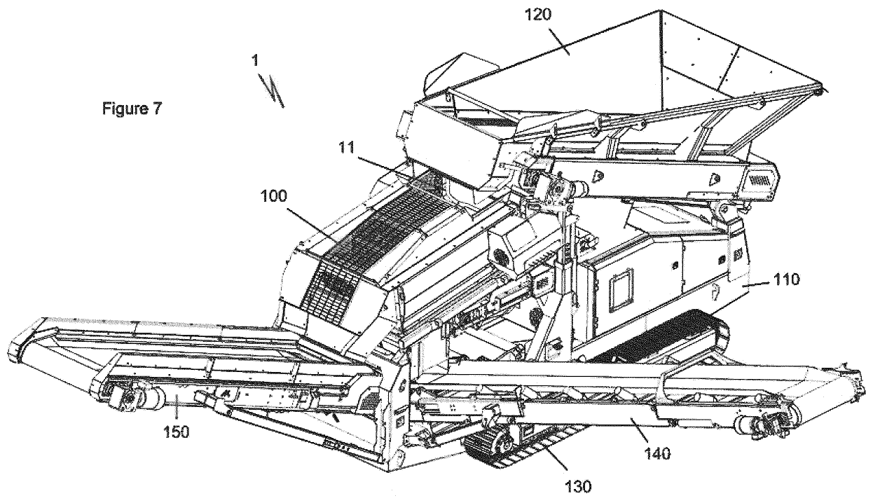

FIG. 7 shows a preferred screening apparatus according to the invention, generally referred to herein by reference numeral 1. As shown, screening apparatus 1 comprises frame 110, feed hopper 120 mounted at one end of frame 110 and screen 100 angled and mounted on frame 110 such that feed inlet 11 is located beneath the output end of feed hopper 120 and feed inlet 111 is higher than outlet 70.

In the preferred embodiment shown in FIG. 7, screening apparatus 1 further comprises tracks 130. Additionally, screening apparatus 1 further comprises conveyor 140 to collect and stockpile screened fines material and conveyor 150 to collect and stockpile screened oversize material.

It is to be understood that the invention is not limited to the specific details described herein which are given by way of example only and that various modifications and alterations are possible without departing from the scope of the invention as defined in the appended claims.

The invention claimed is:

1. A screen for accepting waste material containing fines material and oversize material, wherein the screen comprises:
a trough with a base, a top opening, a base opening for discharging the fines material and an oversize material outlet for discharging the oversize material;
driven elongate rotating members for causing movement of the waste material, wherein each of the driven elongate rotating members has a shaft and a plurality of mutually parallel blades, wherein each of the plurality of mutually parallel blades independently has a plurality of radial protrusions which act on the waste material during the movement thereof, wherein at least one of said plurality of mutually parallel blades on each shaft acts independently, and at least one of the plurality of radial protrusions on each of said plurality of mutually parallel blades is an extended radial protrusion,
wherein the material to be screened is introduced at a first end of each shaft and expelled at an opposite second end,
characterised in that each of the driven elongate rotating members is independently held and rotatably mounted at both said first end and said opposite second end,
wherein the driven elongate rotating members comprise a first plurality of driven elongate rotating members disposed in a first arc along a first side and along at least a portion of the base of the trough for causing circular or helical flow of the waste material and a second plurality of driven elongate rotating members disposed in a second arc along a second side of the trough and along at least a portion of the base of the trough for causing circular or helical flow of the waste material,
wherein, for the driven elongate rotating members, at least one runs at a different speed, and wherein the speed of the driven elongate rotating members does not decrease towards the top opening of the trough.

2. The screen of claim 1, wherein the speeds of the driven elongate rotating members on ene the first side of the trough are a mirror of the speeds on the second side.

3. The screen of claim 1 wherein the driven elongate rotating members include at least three rotating members.

4. The screen of claim 1, wherein each of the driven elongate rotating members is adjacent another of the driven elongate rotating members that is running at a different speed.

5. A screening apparatus comprising a frame, a feed conveyor mounted at one end of the frame and a screen according to claim 1.

6. The screen of claim 1, wherein the driven elongate rotating members include from 4 to about 12 driven elongate rotating members.
